(19) United States
(12) Patent Application Publication
(10) Pub. No.: US 2003/0202198 A1
(43) Pub. Date: Oct. 30, 2003

(54) Printing system

(76) Inventor: Hannah Catharine North, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/131,880

(22) Filed: Apr. 24, 2002

(51) Int. Cl. G06F 15/00; G06F 3/12; G06F 13/00

(52) U.S. Cl. 358/1.13

(57) ABSTRACT

A computer system is described. The computer system includes a computer and a printer. The printer is capable of printing documents in color or in monochrome. The computer may be set to default to color mode printing when using the printer to print a document. When printing a document to the printer, computer is configured to determine if the document meets pre-determined criteria. If so, the computer prints the document in monochrome. If not, the computer prints the document in color.

### BACKGROUND

Printing devices, such as printers, fax machines, and copiers are virtually omnipresent, and can be found in homes and offices worldwide.

The development of such devices has facilitated improvements in communication that have in turn fostered an enormous change in the way people live and work.

Today, however, many users and business organizations are concerned with the operational costs of their printers. Ways are needed to reduce these costs.

### SUMMARY

According to one embodiment (among others) a printing device is provided. The printing device may include apparatus for receiving a print job. The print job directs the printing device to print a color document while operating in a color mode. The printing device may further include apparatus for responding to the print job by printing the print job in a monochrome mode if the document meets pre-determined criteria and in color mode if the document does not meet the criteria.

### BRIEF DESCRIPTION OF THE DRAWINGS

FIG. 1 is a block diagram of a computing system that incorporates one embodiment (among others) of the invention;

FIGS. 2A-B is a flow diagram for illustrating one example of how a computer can operate to print a document using a printer;

FIG. 3 depicts a computing system that incorporates a second embodiment (among others) of the invention;

FIG. 4 is a flow diagram for illustrating one example of the operation of a printer in the second embodiment;

FIG. 5 is a flow diagram for illustrating a second example of the operation of the printer in the second embodiment;

FIGS. 6A and 6B is a flow diagram illustrating a third embodiment (among others) in the form of a method of printing a document.

### DESCRIPTION

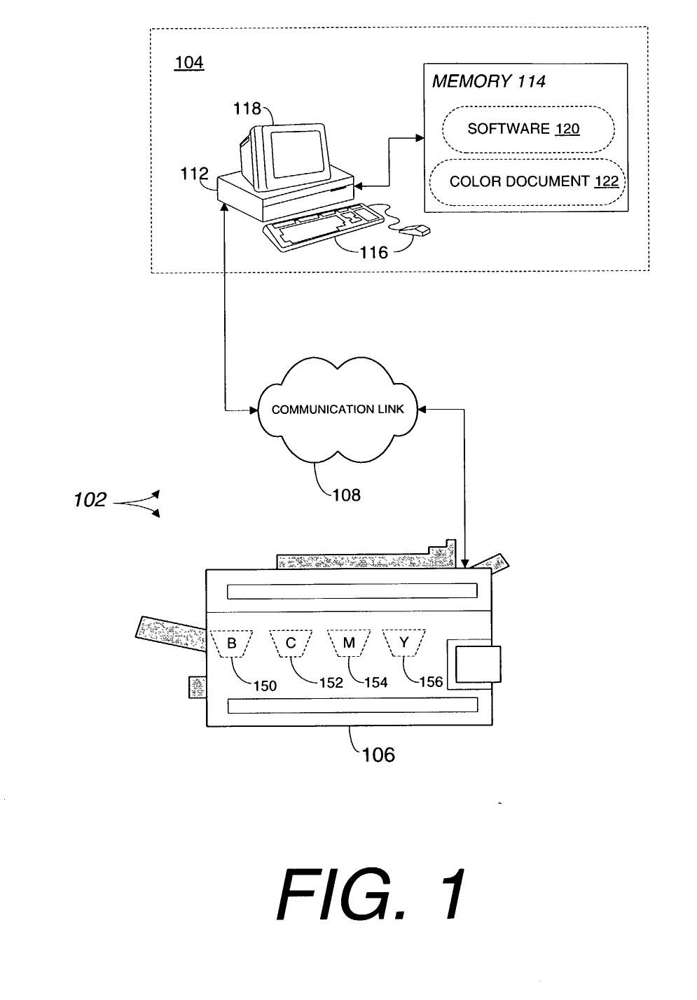

FIG. 1 depicts a computing system 102 that incorporates one embodiment (among others) of the invention. In this example, the computing system 102 includes a computer 104 connected to a printing device 106 over a communication link 108.

The communication link 108 may represent any suitable communication resource that allows the computer 104 to electronically transmit a print job to the printer 106. Thus, the communication link 108 may include a wired connection or wireless connection or some combination thereof. In some implementations, the communication link 108 may include a local communication link such as a parallel or a serial port. In other implementations, the communication link 108 represents a network or a network system such as the Public Internet.

Printer Construction and Operation

The printing device 106, in this illustrative embodiment, represents a laser type printer. In other embodiments, the printing device 106 may represent another type of printer, such as an ink printer.

In this example, the printing device 106 includes four replaceable toner cartridges. A first toner cartridge 150 provides the color black; a second toner cartridge 152 provides the color cyan; a third toner cartridge 154 provides the color yellow; and a fourth toner cartridge 156 provides the color magenta.

The printing device 106 can selectively print a document in a “monochrome mode” or in a “color mode”. If the printing device 106 prints a document while operating in a monochrome mode, only toner from the first toner cartridge 150 is used to print the document. For ease of discussion, this type of printing may be referred to herein as “monochrome mode printing”. If the printing device 106 prints a document while operating in a color mode, toner from up to all four toner cartridges may be used to print the document. This type printing may be referred to herein as “color mode printing”.

It is noted for the later discussion that the costs associated with color mode printing are typically higher than monochrome mode printing. In part this can be due to the increased toner or ink usage typically associated with color mode printing as compared to monochrome mode printing.

For ease of the later discussion, a print job that directs the printing device 106 to print a document in color mode may be referred to herein as a “color print job”. A print job that directs the printing device 106 to print a document in monochrome mode may be referred to herein as a “monochrome print job”.

Additionally, the phrase “color document” refers to a document that includes at least one color that requires color mode printing to print. For example, a document that includes red and blue text characters, in this embodiment, qualifies as being a “color document”.

Computer Construction

The computer 104 may represent a personal computer, a workstation, or other like device. As shown, the computer 104 includes a processor unit 112, a memory 114, user input devices 116 and a display device 118.

The processing unit 112 includes the appropriate I/O resources to both communicate over the communication link 108 and to access the memory 114. The processing unit 112 is also capable of executing the various programs stored in the memory 114. The memory 114 may be physically located internally or externally to the processing unit 112, or some combination thereof. Furthermore, the memory 114 may comprise a portable storage device, such as a magnetic storage device or an optical based portable storage device.

Stored in the memory 114 is software 120. The software 120 provides the computer 104 with the capability to create and print a document using the printing device 106. The software 120, in this illustrative example, represents an application (e.g., a word processing application) and a print driver. Also stored in the memory 114 is a color document 122.

Computer Operation

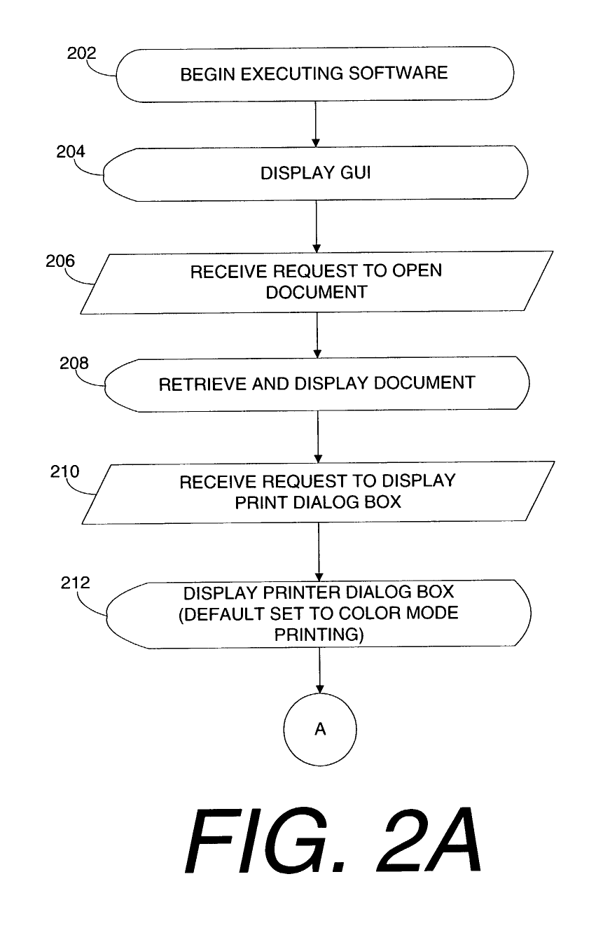

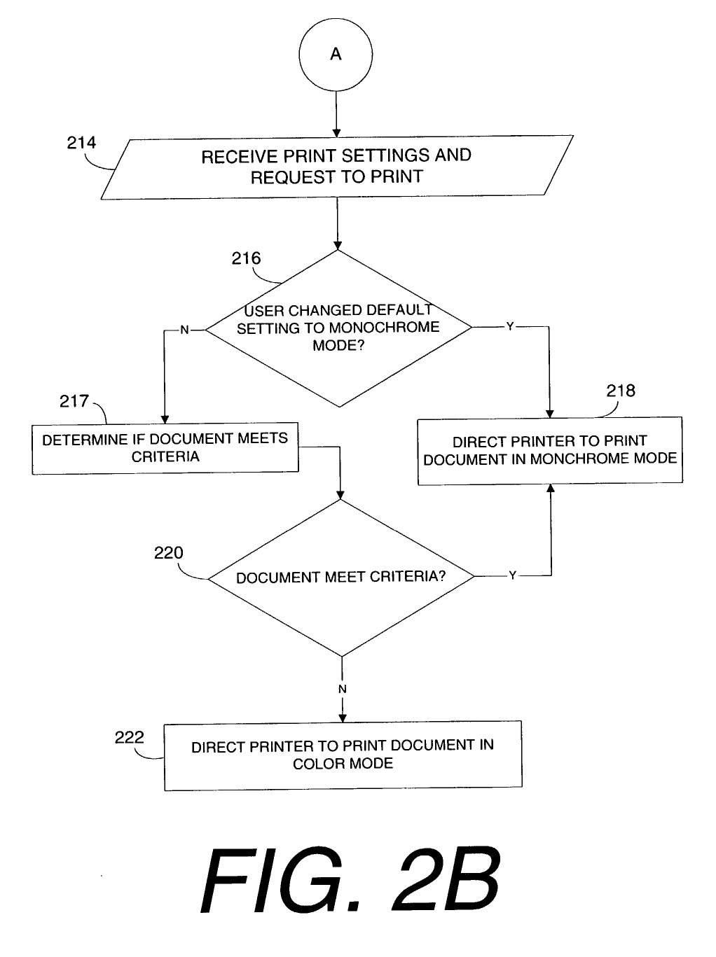

FIGS. 2A-B is a flow diagram for illustrating one example of how the computer 104 can operate, under the direction of the software 120, to print the color document 122 using the printer 106.

As the steps in FIGS. 2A-B are discussed, the user of the computer 104 is assumed to provide certain input, which is described below in italics. Also, it will be assumed that the computer 104 is presently set to default to “color mode printing” when using the printer 106 to print a document.

Turning now to FIG. 2A, the computer 104 begins executing the software 120 (step 202). At step 204, the software 120 displays a graphical user interface (GUI) that enables a user of the computer 104 (by providing appropriate input) to:

(a) open and view the color document 122; and

(b) display a printer dialog box for printing to the printer 106.

We assume the user interacts with the GUI in order to input a request to open and view the color document 122. The software 120 receives this request at step 206 and responds by retrieving the document 122 from the memory 114 and then displaying the document 122 (step 208).

We assume the user then further interacts with the GUI in order to request the printer dialog box be displayed. The software 120 receives this user request at step 210 and responds by displaying the printer dialog box (step 212).

The printer dialog box provides a user interface to the printer 106 for enabling the user (if desired), to change various default print settings. For example, the user may specify the number of copies he/she wishes to print. It is specifically noted, for the later discussion, that the printer dialog box provides the user with the option of changing the default print mode setting from “color mode printing” to “monochrome mode printing”.

After changing the default print settings, the user can then select an “OK” option (provided by the printer dialog box) in order to send the document 122 (in the form of a print job) to the printer 106 for printing.

We assume the user interacts with the dialog box to change various print settings. The user then selects the dialog box “OK” option. The software 120 receives this user input at step 214.

If the user input received at step 214 indicates the user has changed the default print mode setting from “color mode printing” to “monochrome mode printing”, the software 120 responds by directing the printer 106 to print the document 122 in monochrome mode (decision step 216 and step 218).

Step 218 may be accomplished by the software 120 converting the document 122 into a monochrome print job and transmitting the monochrome print job to the printer 106. The printer 106 responds by printing the document 122 in monochrome mode. Therefore, a monochrome version of the document 122 is printed.

If, however, the default “color mode printing” setting was not changed by the user, the software 120 proceeds to determine if the document 122 meets pre-determined criteria (step 217). If the software 120 determines the document 122 does not meet the criteria, then the software 120 directs the printer 106 to print the document 122 in color mode (decision step 220, step 222).

Step 222 may be accomplished by the software 120 converting the document 122 into a color print job and transmitting the color print job to the printer 106. The printer 106 responds by printing the document 122 in color mode. Therefore, a color version of the document 122 is printed.

If, however, the software 120 determines the document 122 does meet the criteria, then the software 120 ignores the “color mode printing setting” and proceeds to direct the printer 106 to print the document 122 in monochrome mode (decision step 220, step 218).

For ease of discussion, the criteria used at step 217 to determine whether or not to ignore the color print mode setting in favor of monochrome mode printing may be referred to herein as the “color mode override” (CMO) criteria.

Selection of CMO Criteria

Before discussing the selection of the CMO criteria, it is first noted that color mode printing and monochrome mode printing each have their respective advantages and disadvantages. Printing a document in monochrome, for example, can be less expensive as compared to printing the same document in color. A document printed in color, however, can often convey more information and can be more visually appealing than the same document printed in monochrome.

A user, however, may not always wish to take the time to consider the advantages and disadvantages of color mode printing versus monochrome mode printing. In fact, a user may not be cognizant of some of these advantages and disadvantages. Also, in a business environment, the business may not wish users to print some types of documents in color mode so as to reduce the operational costs of their printers.

With this in mind, the CMO criteria can be selected in order to prevent color mode printing when monochrome mode printing would be more desirable. The following provides some non-limiting examples of CMO criteria that may be used in specific implementations of the present embodiment.

### EXAMPLE #1

E-mails and Text Files

Suppose, for example, it has been determined that e-mails should be printed in monochrome mode printing rather than in color mode in order to reduce the operational costs of printing such documents. Under this scenario, the CMO criteria may be defined so that an e-mail would meet the criteria. This would prevent a user from inadvertently using the printer 106 to print an e-mail in color.

Along similar lines, the CMO criteria may also be defined so that a text file would meet the criteria. This would prevent a user from inadvertently printing a text file in color when monochrome printing would be more desirable.

### EXAMPLE #2

Color Coverage

In a second example, suppose it is considered likely that the benefits of monochrome mode printing will typically outweigh the benefits of color mode printing if the “color coverage” of the document being printed is below a certain threshold. As used herein, the phrase “color coverage” refers to the area of the document that consists of a color (e.g., blue or red) that requires color mode printing to produce.

Thus, the CMO criteria may be defined so that documents that have a color coverage below a certain threshold would meet the criteria. This would prevent such documents from being printed in color.

### EXAMPLE #3

Document Classification

In a third example, suppose it is considered likely that the benefits of monochrome mode printing will typically outweigh the benefits of color mode printing if the document being printed falls into a particular classification.

For example, suppose the software 120 represents a word processing application that can classify an electronic document as being a “draft”. Suppose further that it is considered generally desirable to print draft documents in monochrome rather than in color. Thus, in this third example, the CMO criteria may be defined so that a draft document would meet the criteria. This would prevent such documents from being inadvertently printed in color.

Variations

It is noted that there are a number of variations of the embodiment just described. For example, according to one variation, if the computer 104 determines that the document meets the criteria at step 220, the computer 104 does not immediately proceed to print the document in monochrome. Instead, the computer 104 prompts the user to verify he/she wishes to print the document in color. The prompt may be in the form of a displayed message. The message may indicate that color mode printing can be more expensive than monochrome mode printing. The message may also request the user provide input to verify he/she wants the document to be printed in color. If the user verifies color printing, the computer 104 would then proceed to print the document in color. If, however, the user input indicates he/she wishes the document to be printed in monochrome, the computer would proceed to print the document in monochrome.

It is noted that one advantage of the variation just described is that the user is not precluded from printing documents that meet the CMO criteria in color. Also, the message would ensure that the user, if he/she chooses color mode printing over monochrome mode printing, has made an informed choice.

Second Embodiment

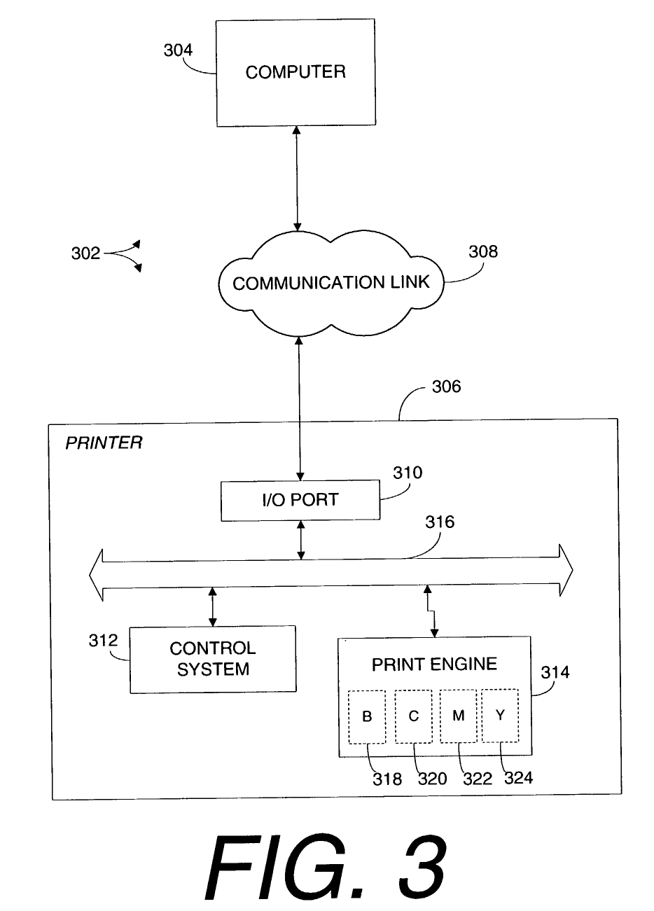

FIG. 3 depicts a computing system 302 that incorporates another embodiment (among others) of the invention. In this second embodiment, the computing system 302 includes a computer 304 connected to a printer 306 over a communication link 308.

The computer 304 is capable of sending a print job, over the communication link 308, to the printer 306.

The printer 306 includes an I/O port 310, a control system 312 and a print engine 314 all connected via an internal communication system 316. The I/O port 310 provides the printer 306 with the capability to receive a print job over the communication link 308 from the computer 304.

The print engine 314 includes the necessary hardware to print a document in a monochrome mode or alternatively in a color mode. The print engine 314, for example, includes four imaging material supplies. The imaging material supplies may represent, for example, toner cartridges or ink cartridges.

The imaging material supplies includes a first supply (black supply) 318 that provides the color black. The second supply 320, third supply 322 and fourth supply 324 provide the colors cyan, yellow and magenta color respectively. In other embodiments, of course, other colors may used. Also, more than one color may be provided by a single cartridge. For example, the colors cyan, yellow and magenta may be provided from a single cartridge.

The control system 312 controls the operation of the printer 306 and can direct the printer 306 to print a document in either monochrome or in color. It is noted that the control system 312 may include hardware (e.g., processor(s), state-machine(s), etc) and/or firmware modules.

When operating in the monochrome mode, the printer 306 makes use of only the black supply 318 to print a document. When operating in the color mode, the printer 306 can make use of all of the imaging material supplies to print a document.

In this embodiment, the printer 306 includes an “economy printing option”. A user and/or a system administrator may set this option. As will be discussed below, the economy printing option can reduce the operational costs of the printer 306 under some conditions by printing some documents in monochrome rather than in color.

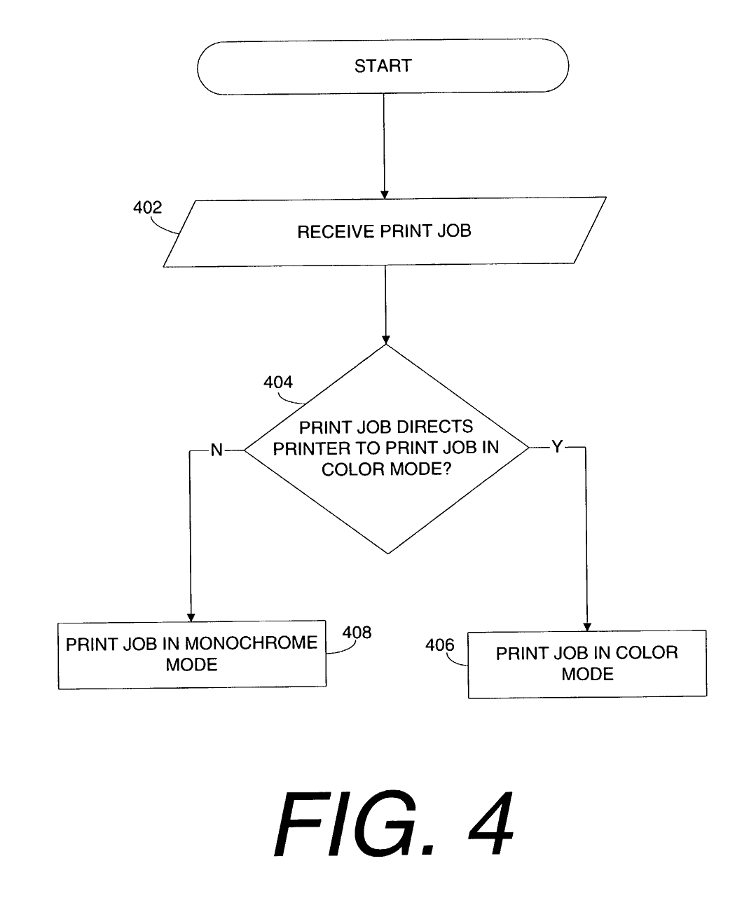

FIG. 4 is a flow diagram for illustrating the operation of the printer 406 to receive and respond to a print job when the economy printing option is not selected.

Turning now to FIG. 4, the printer 306 receives a print job over the communication link 308 (step 402). If the print job directs the printer 306 to print the document in monochrome, then the printer 306 responds by printing the document in monochrome (step 404 and step 408). Thus, only the black supply 318 is used to print the document.

If, however, the print job directs the printer 306 to print the document in color, the printer 306 responds by printing the document in color (step 404 and step 406). Thus, the entire set of imaging supplies (black, cyan, magenta and yellow) may be used to print the document.

As indicated above, a print job that directs the printer 306 to print a document in color mode may be referred to herein as a “color print job”. A print job that directs the printer 306 to print a document in monochrome mode may be referred to herein as a “monochrome print job”.

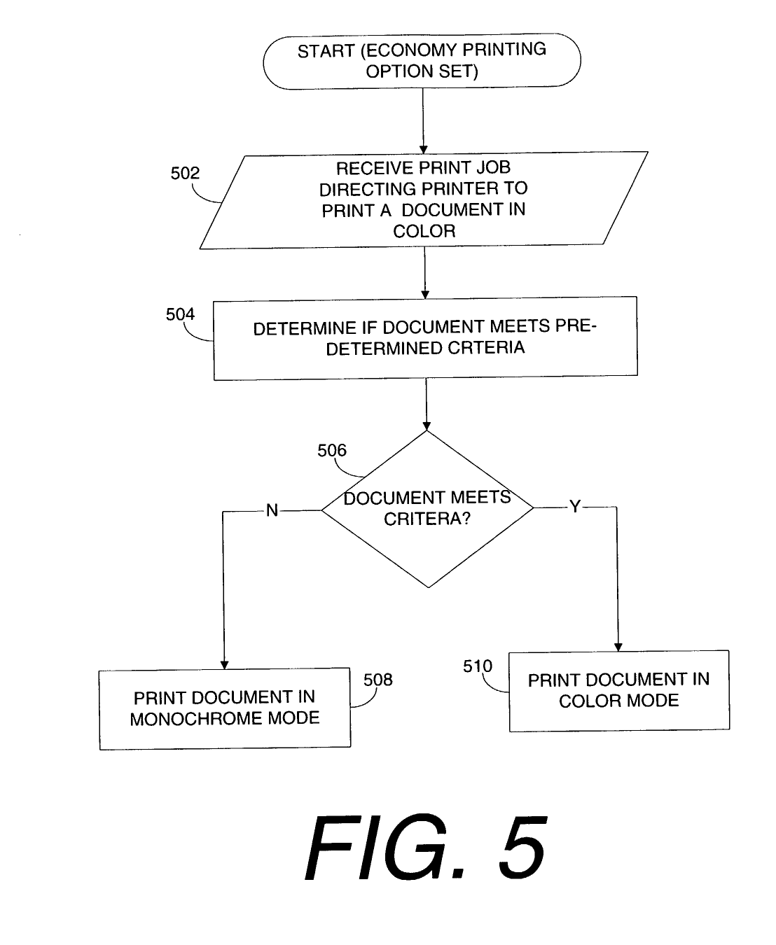

FIG. 5 is a flow diagram for illustrating the operation of the printer 306 to receive and respond to a color print job when the economy print option is selected.

Turning now to FIG. 5, the printer 306 receives a color print job over the communication link 308 (step 502). In response, the printer 306 determines if the document described by the color print job meets certain pre-determined criteria (step 504). If the document described by the print job does not meet the pre-determined criteria, then the printer 306 proceeds to print the job in color (step 508).

If, however, the document described by the print job does meet the pre-determined criteria, then the printer 306 proceeds to print the job in monochrome. Thus, the printer 306 ignores the commands included in the print job that direct the printer 306 to print the job in color.

It is noted that the CMO criteria described above may also be used in this embodiment. This can serve to prevent color mode printing of some jobs (in favor of monochrome mode printing) in order to reduce printer operational costs.

Third Embodiment

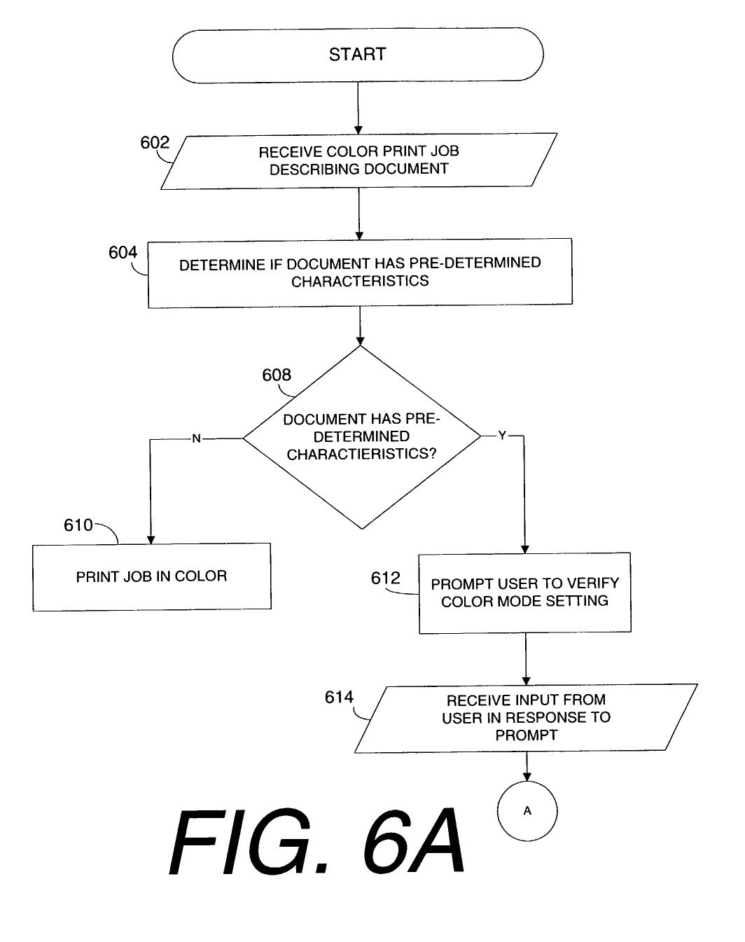

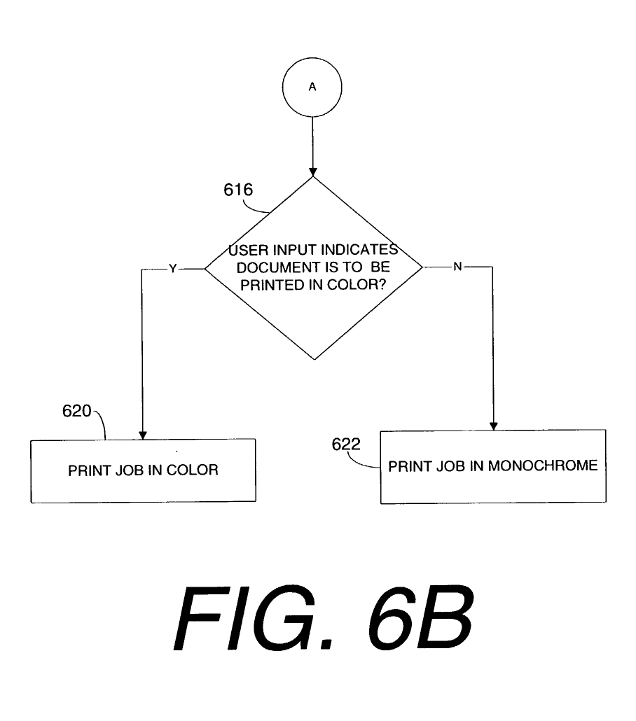

FIGS. 6A-B is a flow diagram illustrating a third embodiment (among others) in the form of a method of printing a document. Turning now to FIG. 6A, a printer receives a color print job (step 602). At step 604, the printer determines if a document described by the print job has certain pre-determined characteristics (step 604).

If not, the printer proceeds to print the print job in color (step 608 and step 610).

If, however, the printer determines the document has the pre-determined characteristic, the printer prompts the user to verify that he/she wishes the document to be printed in color (decision step 608, step 612).

At step 614, the user provides input in response to the prompt. The input indicates whether or not the user wishes the document to be printed in color or in monochrome.

If the user input indicates the document is to be printed in monochrome (decision step 616), the printer proceeds to print the document in color (step 620). If, however, the user indicates the document should be printed in monochrome, the printer 604 proceeds to print the document in monochrome (step 622). Thus, at step 622 the printer ignores the direction of the color print job to print the document in color. As a result, the operational cost of the printer to print the document may be reduced.

Other Embodiments

It is also important to note that the present invention may be embodied in the form of a “computer-readable medium” that stores (either temporarily or permanently) computer executable instructions for performing the steps depicted in one or more of the flow diagrams described above. As used herein, the phrase “computer-readable medium” can refer to any medium that can contain, store or propagate computer executable instructions. Thus, in this document, the phrase “computer-readable medium” may refer to a medium such as a CD ROM or a magnetic storage device. The phrase “computer-readable medium” may also refer to signals that are used to propagate the computer executable instructions over a network or a network system, such as the Public Internet.

Although several specific embodiments of the invention have been described and illustrated, the invention is not to be limited to specific forms or arrangements of parts so described and illustrated. The invention is limited only by the claims and the equivalents thereof.

What is claimed is:

1. In a computer, a method of using a remote printer capable of selectively printing a document in a color mode or in a monochrome mode, the method comprising:
(a) receiving a request to print a color document in color;
(b) determining whether the color document meets pre-determined criteria; and
(c) if the color document is determined to meet the pre-determined criteria, then responding to the request by directing the printer to print the color document in the monochrome mode.

2. The method of claim 1, wherein step (c) comprises the following substeps:
(i) determining whether the document is an e-mail; and
(ii) if the document is determined to be an e-mail, then determining that the color document meets the pre-determined criteria.

3. The method of claim 2, further comprising:
(d) if the document is determined not to meet the criteria, then responding to the request by directing the printer to print the color document in the color mode.

4. The method of claim 1, wherein an e-mail meets the criteria.

5. The method of claim 1, wherein a document having color coverage below a pre-determined threshold meets the criteria.

6. The method of claim 1, wherein a document that falls into a pre-determined classification meets the criteria.

7. A computer, comprising:
(a) means for receiving a request to print a color document using a remote printer capable of selectively printing documents in color or in monochrome; and
(b) means for responding to the request by directing the printer to print the color document; and
wherein the responding means directs the printer to print the color document in monochrome if the color document meets pre-determined criteria; and
wherein the responding means directs the printer to print the color document in color if the color document does not meet the pre-determined criteria.

8. The computer of claim 7, wherein the responding means directs the printer to print the color document in monochrome if the document is an e-mail.

9. The computer of claim 7, wherein an e-mail meets the criteria.

10. The computer of claim 7, wherein a text-file meets the criteria.

11. The computer of claim 7, wherein a document that falls into a pre-determined classification meets the criteria.

12. A computer-readable medium storing computer executable instructions for performing the steps of:
(a) receiving a request to print a document in color;
(b) if the document meets pre-determined criteria, then responding to the request by directing a printer to print the document in monochrome; and
(c) if the document does not meet the pre-determined criteria, then responding to the request by directing the printer to print the document in color.

13. The computer-readable medium of claim 12, wherein an e-mail meets the criteria.

14. The computer-readable medium of claim 12, wherein an e-mail, a text file and a document having a color coverage below a pre-determined threshold all meet the pre-determined criteria.

15. A computer-readable medium storing computer executable instructions for performing the steps of:
(a) receiving a request to print a document in color using a printer capable of selectively printing documents in color or in monochrome;
(b) if the document meets pre-determined criteria, then responding to the request by prompting the user to verify that he/she wishes to print the document in color; and
(c) if the color document does not meet the pre-determined criteria, then responding to the request by directing the printer to print the color document in color.

16. The computer-readable medium of claim 15, wherein an e-mail meets the criteria.

17. In a printer capable of printing in a monochrome mode or alternatively in a color mode, a method comprising:
(a) receiving a print job directing the printer to print a document in color;
(b) determining if a document described by the print job meets pre-determined criteria;
(c) if the document is determined to meet the criteria, then printing the document in monochrome.

18. The method of claim 17, further comprising:
(d) if the document is determined not to meet the pre-determined criteria, then printing the document in color.

19. The method of claim 18, wherein the document meets the pre-determined criteria if the document has at least one pre-determined characteristic that indicates the document is an e-mail.

20. The method of claim 18, wherein the document meets the pre-determined criteria if the document has at least one pre-determined characteristic that indicates the document is a text file.

21. The method of claim 17, wherein the document meets the pre-determined criteria if the document has a color coverage below a pre-determined threshold.

22. A printing device, comprising:
(a) means for receiving a print job directing the printing device to print a color document while operating in a color mode
(b) means for printing the document in a monochrome mode if the document meets pre-determined criteria; and
(c) means for printing the document in a color mode if the document does not meet the pre-determined criteria.

23. The printing device of claim 22, wherein the document meets the pre-determined criteria if the document is an e-mail.

24. The printing device of claim 22, wherein the document meets the pre-determined criteria if the document is a text file.

25. A printer capable of printing a document in color or in monochrome, the printer comprising:
(a) apparatus capable of receiving, from a remote computer, a print job describing a document;
(b) apparatus capable of analyzing the print job to determine if the document is likely an e-mail; and
(c) apparatus capable of responding to the print job by printing the document in monochrome if the document is determined likely to be an e-mail; and
(d) wherein the print job directs the printer to print the document in color.

26. The printer of claim 25, further comprising:
(e) apparatus capable of responding to the print job by printing the document in color if the document is not determined likely to be an e-mail.
